(19) United States
(12) Patent Application Publication
(10) Pub. No.: US 2017/0033368 A1
(43) Pub. Date: Feb. 2, 2017

(54) Oxidative Control of Pore Structure in Carbon-Supported PGM-Based Catalysts

(71) Applicant: GM GLOBAL TECHNOLOGY OPERATIONS LLC, Detroit, MI (US)

(72) Inventors: Michael K. CARPENTER, Troy, MI (US); Zhongyi LIU, Troy, MI (US); Anusorn KONGKANAND, Rochester Hills, MI (US)

(21) Appl. No.: 14/815,450

(22) Filed: Jul. 31, 2015

(51) Int. Cl. H01M 4/92; H01M 8/1018

(52) U.S. Cl. CPC H01M 4/926; H01M 8/1018; H01M 2008/1095; H01M 2300/0082

(57) ABSTRACT

A carbon supported catalyst includes a carbon support having an average micropore diameter is less than about 70 angstroms and a platinum-group metal being disposed over the carbon support. A method for making the carbon supported catalyst includes a step of providing a first carbon supported catalyst having a platinum-group metal supported on a carbon support. The first carbon supported catalyst has a first average micropore diameter, and a first average surface area. The first carbon supported catalyst is contacted with an oxygen-containing gas at a temperature less than about 250° C. for a predetermined period of time to form a second carbon supported catalyst. The second carbon supported catalyst has a second average pore diameter and a second average surface area. Characteristically, the second average pore diameter is greater than the first average pore diameter, and the second average surface area is less than the first average surface area.

### TECHNICAL FIELD

In at least one aspect, the present invention relates to catalyst materials for fuel cells with improved performance.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel and oxidant to disperse over the surface of the membrane facing the fuel- and oxidant-supply electrodes, respectively. Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

High surface area carbon black is often used as a support for fuel cell catalysts. High surface area carbon black often contains large quantities of internal micropores (<4 nm) in their constituent particles. Pt nanoparticles deposited in these micropores can have restricted access to reactants and show poor activity. Studies have shown that up to 80% of all Pt particles are deposited inside the micropores. Opening up these micropores to better expose the Pt particles should improve the high power performance of the catalyst. As used herein, the terms “micropores” and “pores” are used interchangeably, not to be mistaken with mesopores (pores of 5-15 nm) and macropores (pores >15 nm).

Catalyst durability, particularly as it relates to the retention of high power performance, is one of the major challenges facing the development of automotive fuel cell technology. Platinum or platinum-alloy particles lose electrochemical surface area during operation due to dissolution and subsequent Ostwald ripening and to particle migration and coalescence. Electrochemical oxidation of the carbon support enhances this particle migration and subsequent performance loss at high power. Oxidation of carbon support also causes the collapse of the electrode thickness and electrode porosity, hindering reactant transport and subsequent performance loss. Therefore, it is a common practice for those skilled in the art to avoid oxidation of carbon support.

Accordingly, there is a need for more durable catalyst systems for the fuel cell catalyst layers.

### SUMMARY

The present invention solves one or more problems of the prior art by providing, in at least one embodiment, a carbon supported catalyst for fuel cell application. The carbon supported catalyst includes a platinum group metal and a carbon support having a plurality of pores. The plurality of pores has an average pore diameter that is greater than about 50 angstroms. The platinum group metal is disposed over/supported on the carbon support.

In another embodiment, a method for forming the carbon supported catalyst set forth above is provided. The method includes a step of providing a first carbon supported catalyst having a platinum-group metal disposed over/supported on a carbon support. The first carbon supported catalyst includes a first carbon support having a first average pore diameter and an average surface area. The first carbon supported catalyst is contacted with an oxygen-containing gas at a temperature less than about 250° C. for a predetermined period of time to form a second carbon supported catalyst. The second carbon supported catalyst includes an altered carbon support having a second average pore diameter and a second average surface area. Characteristically, the second average pore diameter is greater than the first average pore diameter and the second average surface area is less than the first average surface area. Advantageously, the present embodiment uses controlled oxidation of the carbon support to improve the performance and durability of carbon-supported catalysts.

### BRIEF DESCRIPTION OF THE DRAWINGS

FIG. 1 is a schematic cross section of a fuel cell that incorporates carbon supported catalysts into the anode and/or cathode catalyst layers;

FIG. 2 is a schematic illustrating the oxidation of a carbon supported PGM catalyst;

FIG. 3A provides a plot of weight loss for a one hour heat treatment for carbon supported catalysts in air;

FIG. 3B provides a plot of weight loss for heat treatment at 230° C. as a function of time for carbon supported catalysts in air;

FIG. 4A is a TEM micrograph of a platinum/cobalt supported catalyst before heat treatment in air at 250° C.;

FIG. 4B is a TEM micrograph of a platinum/cobalt supported catalyst before heat treatment in air at 250° C.;

FIG. 4C provides TEM micrographs of a platinum/cobalt supported catalyst after heat treatment in air at 250° C.;

FIG. 4D provides TEM micrographs of a platinum/cobalt supported catalyst after heat treatment in air at 250° C.;

FIG. 5A is a plot of a volume absorbed versus relative pressure for the carbon supported catalysts;

FIG. 5B is a plot of derivative of the volume absorbed with respect to the log of the pore volume versus pore diameter for the carbon supported catalysts;

FIG. 5C provides a table summarizing the BET results for FIGS. 5A and 5B; and

FIG. 6 provides a plot of fuel cell voltage versus current density for platinum/cobalt supported catalysts that are heat treated and not heat treated.

### DETAILED DESCRIPTION

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

Abbreviations:

“BET” means Brunauer-Emmett-Teller (BET) theory;

“BOL” means beginning of life;

“PGM” means platinum group metal;

“TEM” means transmission electron microscopy;

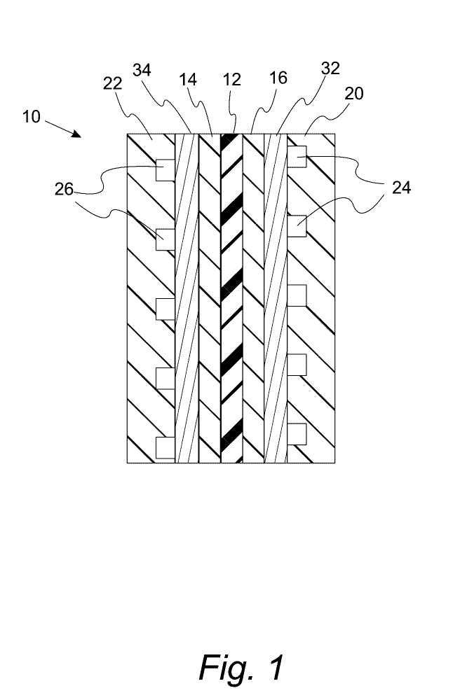

With reference to FIG. 1, a cross sectional view of a fuel cell incorporating the platinum group metal-containing carbon supported catalysts is provided. PEM fuel cell 10 includes polymeric ion conducting membrane 12 disposed between cathode electro-catalyst layer 14 and anode electro-catalyst layer 16. Fuel cell 10 also includes electrically conductive flow field plates 20, 22 which include gas channels 24 and 26. Flow field plates 20, 22 are either bipolar plates (illustrated) or unipolar plates (i.e., end plates). In a refinement, flow field plates 20, 22 are formed from a metal plate (e.g., stainless steel) optionally coated with a precious metal such as gold or platinum. In another refinement, flow field plates 20, 22 are formed from conducting polymers which also are optionally coated with a precious metal. Gas diffusion layers 32 and 34 are also interposed between flow field plates and a catalyst layer. Cathode electro-catalyst layer 14 and anode electro-catalyst layer 16 include carbon supported catalysts made by the processes set forth below. Advantageously, the carbon supported catalysts have improved stability anode and cathode electro-catalyst layers.

In one embodiment, the carbon supported catalyst includes a carbon support and a platinum-group metal (PGM) disposed over/supported on the carbon support. In a refinement, the platinum-group metal loading is from about 10 μg PGM/cm² to about 500 μg PGM/cm². The carbon supported catalyst is characterized by the average pore diameter which is typically greater than 50 angstroms. In a refinement, the average pore diameter is greater than, in increasing order of preference, 50 angstroms, 55 angstroms, 60 angstroms, or 70 angstroms. In another refinement, the average pore diameter is less than, in increasing order of preference, 150 angstroms, 120 angstroms, 100 angstroms, or 90 angstroms. The carbon supported catalyst is also characterized by its average surface area which is less than 500 m²/g. In a refinement, the average surface area is less than, in increasing order of preference, 500 m²/g, 400 m²/g, 300 m²/g, or 200 m²/g. In another refinement, the average surface area is greater than, in increasing order of preference, 50 m²/g, 75 m²/g, 100 m²/g, or 150 m²/g. In a refinement, the carbon supported catalyst has an average pore volume that is less than about 0.6 cm³/g. In another refinement, the average pore volume is less than, in increasing order of preference, 0.3 cm³/g, 0.5 cm³/g, 0.4 cm³/g, and 0.6 cm³/g. In still another refinement, the average pore volume is greater than, in increasing order of preference, 0.05 cm³/g, 0.1 cm³/g, 0.15 cm³/g, or 0.2 cm³/g. In a variation, the pore volume, pore diameter and surface area are determined by a BET method.

As set forth above, the carbon supported catalyst includes a platinum group metal. The platinum group metal is selected from the group consisting of Pt, Pd, Au, Ru, Ir, Rh, and Os. In particular, the platinum group metal is platinum. In a refinement, the carbon supported catalyst is an alloy that includes the platinum group metal and one or more additional metals. In a refinement, the one or more additional metals include first or second row transition metals. Specific examples of the one or more additional metals include Co, Ni, Fe, Ti, Sc, Cu, Mn, Cr, V, Ru, Zr, Y and W. Typically, the carbon support is a carbon powder having a plurality of carbon particles. The carbon particles may have any number of shapes without limiting the invention in any way. Examples of such shapes include, but are not limited to, nano-rods, nanotubes, nano-rafts, non-electrically conducting particles, spherical particles, and the like. In one variation, the carbon particles are a carbon powder and in particular, a high surface area carbon (HSC) powder typically having an average spatial dimension (e.g., diameter) from about 10 to 500 nanometers. In a refinement, the carbon powder has an average spatial dimension from about 20 to 300 nanometers. In another refinement, carbon black having an average spatial dimension from about 50 to 300 nanometers is used for the carbon particles. A particularly useful example of carbon black is Ketjen Black.

In another embodiment, a method for making the carbon supported catalyst set forth above is provided. The method includes a step of providing a first carbon supported catalyst having a platinum-group metal disposed over/supported on a carbon support. The first carbon supported catalyst has a first average pore volume, a first average pore diameter, and a first average surface area. In a refinement, the first average pore diameter is less than 70 angstroms, and the first average surface area is greater than 500 m²/g. In a refinement, the first average pore diameter is less than, in increasing order of preference 100 angstroms, 80 angstroms, 70 angstroms and 50 angstroms and greater than in increasing order of preference, 10 angstroms, 20 angstroms, 30 angstroms, and 40 angstroms. In another refinement, the first average surface area is greater than, in increasing order of preference, 400 m²/g, 500 m²/g, 600 m²/g, and 700 m²/g and less than, in increasing order of preference, 1200 m²/g, 1000 m²/g, 800 m²/g, and 600 m²/g. Typically, the first average pore volume is greater than 0.6 cm³/g. In another refinement, the first average pore volume is greater than, in increasing order of preference, 0.5 cm³/g, 0.6 cm³/g, 0.7 cm³/g, and 0.8 cm³/g. In still another refinement, the first average pore volume is less than, in increasing order of preference, 1.5 cm³/g, 1.2 cm³/g, 1.0 cm³/g, or 0.9 cm³/g.

The first carbon supported catalyst is contacted with an oxygen-containing gas (e.g., air) at a temperature less than about 250° C. for a predetermined period of time to form a second carbon supported catalyst. The second carbon supported catalyst has a second average pore volume, a second average pore diameter, and a second average surface area. Characteristically, the second average pore diameter is greater than the first average pore diameter and the second average surface area is less than the first average surface area. In a refinement, the second average pore volume is less than the first average pore volume. Details for the second average pore volume, second average pore diameter, and the second average surface area are set forth above. In a refinement, the second average pore volume is less than about 0.6 cm³/g. In another refinement, the second average pore volume is less than, in increasing order of preference, 0.3 cm³/g, 0.5 cm³/g, 0.4 cm³/g, and 0.6 cm³/g. In still another refinement, the second average pore volume is greater than, in increasing order of preference, 0.05 cm³/g, 0.1 cm³/g, 0.15 cm³/g, or 0.2 cm³/g. Similarly, the second average pore diameter is typically greater than 50 angstroms. In a refinement, the second average pore diameter is greater than, in increasing order of preference, 50 angstroms, 55 angstroms, 60 angstroms, or 70 angstroms. In another refinement, the second average pore diameter is less than, in increasing order of preference, 150 angstroms, 120 angstroms, 100 angstroms, or 90 angstroms. Typically, the second average surface area is less than 500 m²/g. In a refinement, the second average surface area is less than, in increasing order of preference, 500 m²/g, 400 m²/g, 300 m²/g, or 200 m²/g. In another refinement, the second average surface area is greater than, in increasing order of preference, 50 m²/g, 75 m²/g, 100 m²/g, or 150 m²/g.

In a refinement, the predetermined period of time is from 15 minutes to 30 hours. In another refinement, the predetermined period of time is from 15 minutes to 2 hours. In another variation, the first carbon supported catalyst is contacted with an oxygen-containing gas at a temperature less than or equal to, in increasing order of preference, 300° C., 250° C., 200° C., 180° C., or 150° C., and at a temperature greater than or equal to 50° C., 75° C., 90° C., 100° C., or 120° C. The oxidation of the first carbon supported catalyst typically is performed at around 1 atm. The oxygen-containing gas is a gas with the ability to oxidize carbon into carbon dioxide at elevated temperature. The oxygen-containing gas can be a gas that directly reacts with carbon such as oxygen gas and air, or a gas that undergoes a disproportion reaction with carbon such as nitrogen oxide gas, sulfur oxide gas, etc. The oxygen-containing gas may be diluted with an inert gas, such as nitrogen or argon, in order to improve control over reaction uniformity. In a refinement, the oxygen-containing gas includes from 0.1 to 100 weight percent molecular oxygen. In another refinement, the oxygen-containing gas includes from 1 to 30 weight percent molecular oxygen.

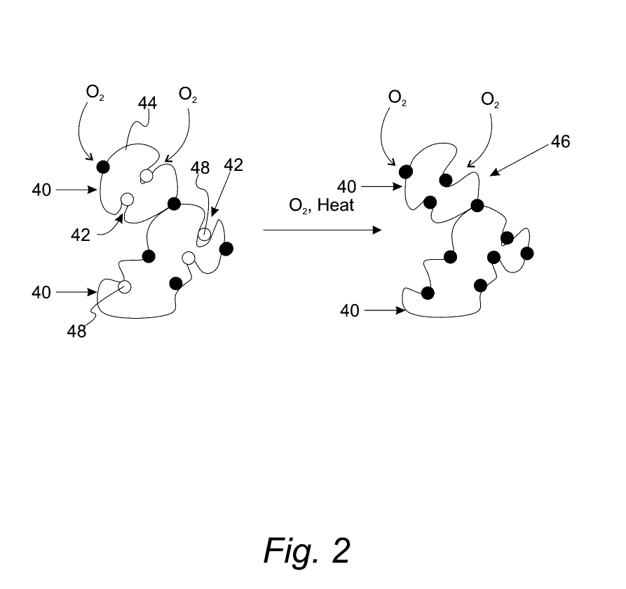

In the method set forth above, the carbon supported PGM catalyst is heated in an oxidizing environment with the platinum group metal catalyst particles serving as oxidation catalyst sites that allow localized corrosion of the micropores in which they reside, resulting in larger pores and improved transport properties. The mild oxidation also preferentially removes some of the less stable amorphous carbon, partially stabilizing the support and thus improving catalyst durability. This process is schematically illustrated in FIG. 2. PGM catalyst particles 40 reside in micropores 42 in first carbon support 44. Some carbon support catalysts can have up to 80% of all catalyst metal particles located inside the micropores. PGM catalyst particles 40 tend to have restricted access to protons and reactant gases such as oxygen and hydrogen when incorporated into a fuel cell. In step a), the first carbon supported catalyst is contacted with an oxygen-containing gas at a temperature less than about 250° C. for a predetermined period of time to form a second carbon supported catalyst 46. During this process, some amorphous carbon that is easily oxidized will be removed. The PGM catalyst particles also catalyze adjacent carbon such that the micropores open up providing an improved accessibility to the catalyst. This can be done without adverse effects on catalyst stability commonly seen with unintended carbon oxidation.

In another embodiment, the carbon supported catalysts set forth above are used in an ink composition to form fuel cell catalyst layers by methods known to those skilled in fuel cell technology. In a refinement, the ink composition includes the carbon supported catalysts in an amount of about 1 weight percent to 10 weight percent of the total weight of the ink composition. In a refinement, the ink composition includes ionomers (e.g., a perfluorosulfonic acid polymer such as NAFION®) in an amount from about 5 weight percent to about 40 weight percent of the catalyst composition. Typically, the balance of the ink composition is solvent. Useful solvents include, but are not limited to, alcohols (e.g., propanol, ethanol, and methanol), water, or a mixture of water and alcohols. Characteristically, the solvents evaporate at room temperature.

The following examples illustrate the various embodiments of the present invention. Those skilled in the art will recognize many variations that are within the spirit of the present invention and scope of the claims.

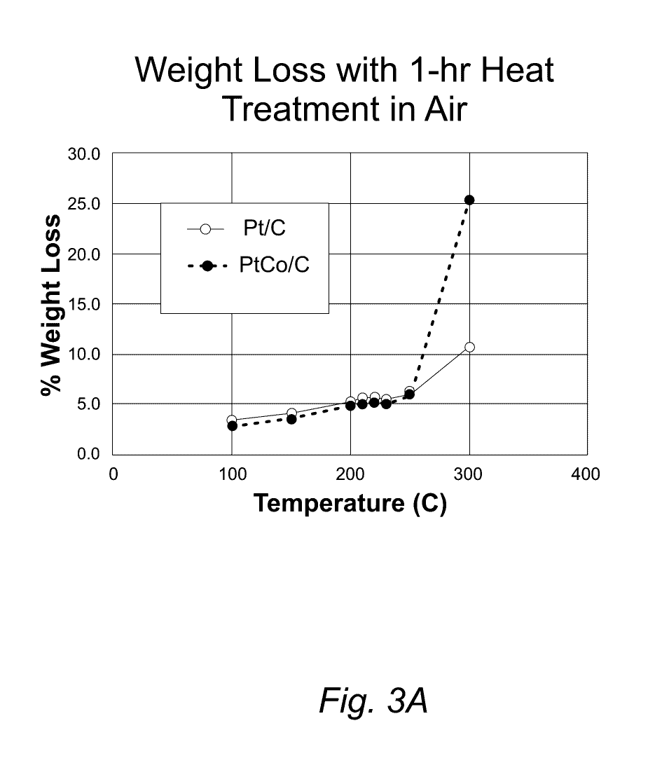

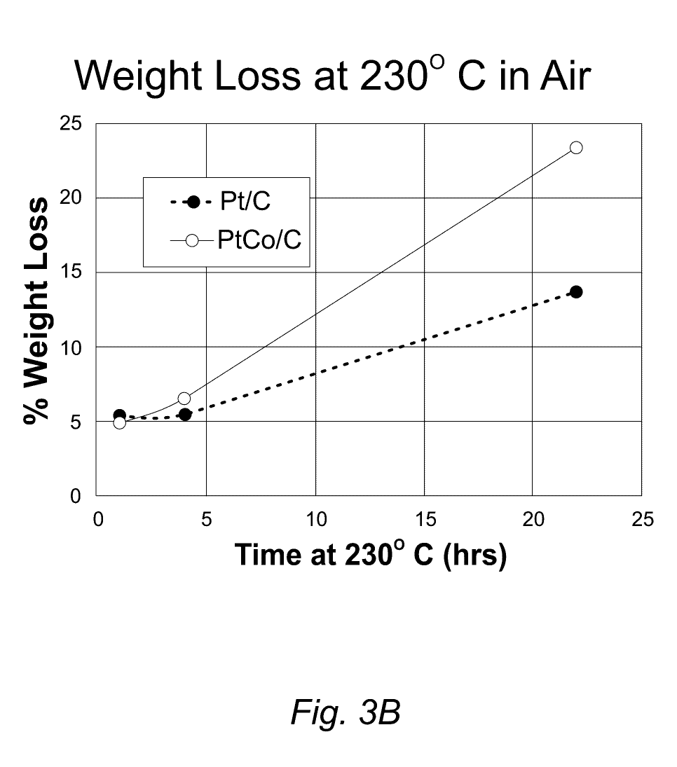

FIG. 3A provides a plot of weight loss for a one hour heat treatment for carbon supported catalysts in air. The plot reveals less than 6 percent weight loss for platinum supported catalysts and platinum/cobalt supported catalysts at temperatures from about 100° C. to about 250° C. Note that this weight loss includes the removal of adsorbed water and volatile compounds such as surfactant, and that not all of the weight loss is due to carbon oxidation. FIG. 3B provides a plot of weight loss for heat treatment at 230° C. as a function of time for carbon supported catalysts in air. For both the platinum supported catalysts and platinum/cobalt supported catalysts the weight loss is observed to be significant after 5 hours.

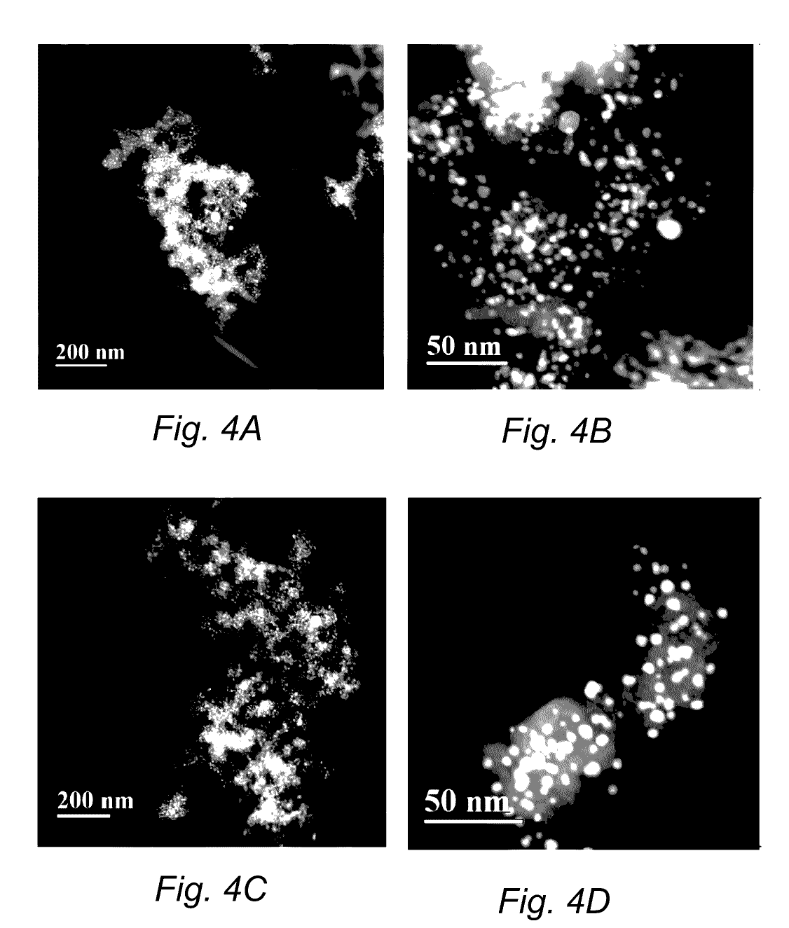

FIGS. 4A-B provide TEM micrographs of a platinum/cobalt supported catalyst before heat treatment in air at 250° C. FIGS. 4C-D provide TEM micrographs of a platinum/cobalt supported catalyst after heat treatment in air at 250° C. The TEM micrographs do not reveal any obvious change after heat treatment.

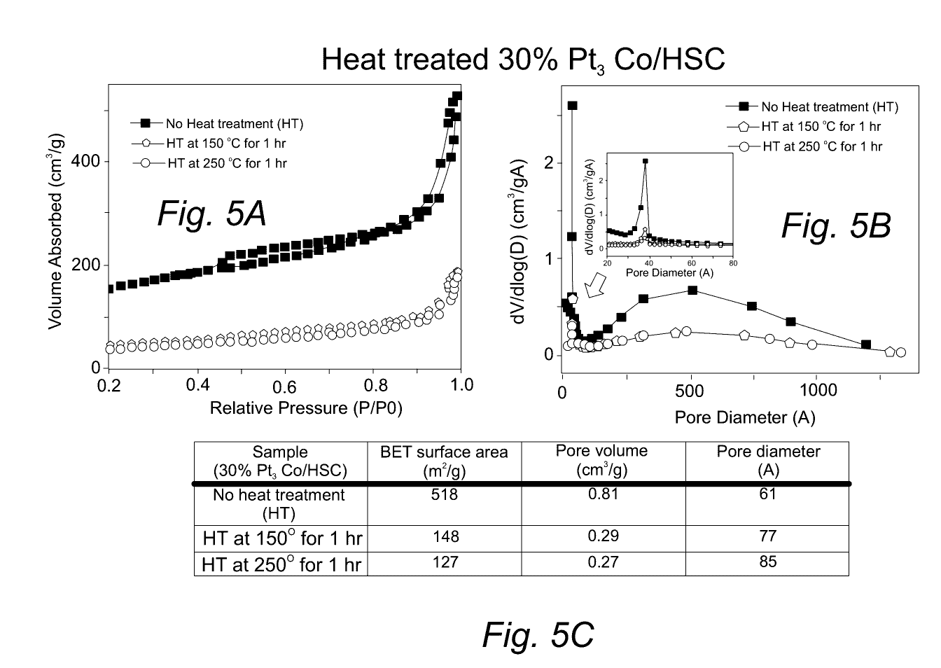

FIGS. 5A-C provide the results of BET absorption experiments for heat treated and not heat treat carbon supported catalysts. FIG. 5A is a plot of a volume absorbed versus relative pressure. FIG. 5B is a plot of derivative of the volume absorbed with respect to the log of the pore volume versus pore diameter. FIG. 5C provides a table summarizing the BET results. It is observed that average pore diameter increases with oxidation treatment while surface area decreases, with little change in catalyst weight (a few percent loss).

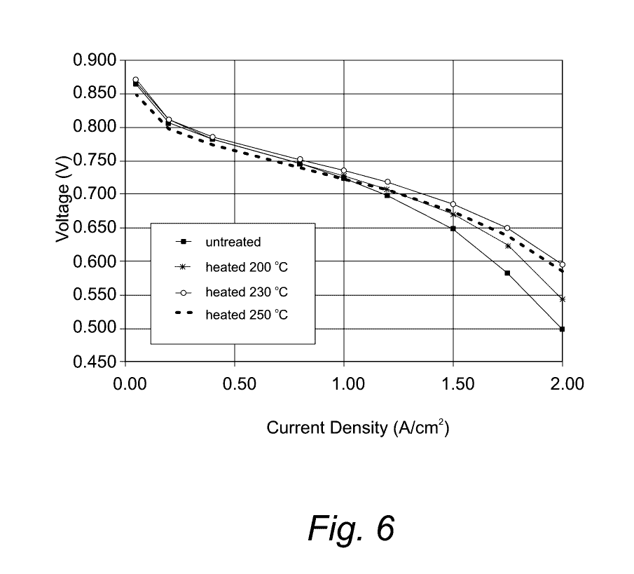

FIG. 6 provides plots of fuel cell voltage versus current density for platinum/cobalt supported catalysts that are heat treated and not heat treated. It is observed that oxidatively modified catalyst have improved high current capability. However, if the oxidative treatment is too extensive, performance can be negatively impacted.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A carbon supported catalyst comprising:
a carbon support having an average pore diameter that is greater than 50 angstroms, and an average surface area less than about 500 m²/g; and
a platinum-group metal being disposed over the carbon support.

2. The carbon supported catalyst of claim 1 wherein the average pore diameter is less than 150 angstroms.

3. The carbon supported catalyst of claim 1 wherein the average surface area is greater than 50 m²/g,

4. The carbon supported catalyst of claim 1 wherein the carbon support has an average pore volume that is less than about 0.6 cm³/g,

5. The carbon supported catalyst of claim 4 wherein the average pore volume is from about 0.1 to about 0.5 cm³/g.

6. The carbon supported catalyst of claim 1 wherein the platinum-group metal is selected from the group consisting of Pt, Pd, Au, Ru, Ir, Rh, and Os.

7. The carbon supported catalyst of claim 1 wherein the platinum-group metal is Pt.

8. The carbon supported catalyst of claim 1 wherein the carbon support is a carbon powder.

9. The carbon supported catalyst of claim 1 wherein the carbon support includes particles selected from the group consisting of nano-rods, nanotubes, nano-rafts, non-electrically conducting particles, spherical particles, and combinations thereof.

10. The carbon supported catalyst of claim 1 wherein the carbon support is a high surface area carbon (HSC) powder.

11. A method for forming a carbon supported catalyst, the method comprising:
providing a first carbon supported catalyst having a platinum-group metal supported on a first carbon support, the first carbon support having a first average pore diameter and a first average surface area; and
contacting the first carbon supported catalyst with an oxygen-containing gas at a temperature less than about 250° C. for a predetermined period of time to form a second carbon supported catalyst, the second carbon supported catalyst including an altered carbon support having a second average pore diameter and a second average surface area, the second average pore diameter being greater than the first average pore diameter and the second average surface area being less than the first average surface area.

12. The method of claim 11 wherein the first average pore diameter is less than 70 angstroms.

13. The method of claim 11 wherein the second average pore diameter is greater than 70 angstroms.

14. The carbon supported catalyst of claim 11 wherein the second average surface area is less than 500 m²/g,

15. The method of claim 11 wherein the first carbon support has a first average pore volume and the altered carbon support has a second average pore volume, the second average pore volume being less than the first average pore volume.

16. The method of claim 15 wherein the second average pore volume is from about 0.1 to about 0.5 cm³/g.

17. The method of claim 11 wherein the platinum-group metal is selected from the group consisting of Pt, Pd, Au, Ru, Ir, Rh, and Os.

18. The method of claim 11 wherein the platinum-group metal is Pt.

19. The method of claim 11 wherein the carbon support is a carbon powder.

20. The method of claim 11 wherein the second average pore diameter is more than 70 angstroms and the second average surface area is less than 500 m²/g.
